(19) United States
(12) Patent Application Publication
(10) Pub. No.: US 2018/0203400 A1
(43) Pub. Date: Jul. 19, 2018

(54) POST-PROCESSING APPARATUS AND CONTROL METHOD THEREOF

(71) Applicants: KABUSHIKI KAISHA TOSHIBA, Tokyo (JP); TOSHIBA TEC KABUSHIKI KAISHA, Tokyo (JP)

(72) Inventor: Jun ISHII, Mishima Shizuoka (JP)

(21) Appl. No.: 15/410,481

(22) Filed: Jan. 19, 2017

(51) Int. Cl. G03G 15/00

(52) U.S. Cl. CPC G03G 15/6582

(57) ABSTRACT

A post-processing apparatus includes a discharge tray, a sheet conveyor configured to convey a sheet onto the discharge tray, a drive unit configured to drive the sheet conveyor, a sensor configured to detect a position of the sheet discharged onto the discharge tray, and a control unit configured to determine a parameter to control the drive unit based on an output of the sensor, and to control the drive unit based on the determined parameter.

### FIELD

Embodiments described herein relate generally to a post-processing apparatus and a control method thereof.

### BACKGROUND

In the related art, a paper discharge tray of a post-processing apparatus has an inclined surface to receive a sheet. After the sheet discharged to the paper discharge tray lands on the paper discharge tray, the sheet slides down the incline and comes into contact with a wall surface, and thereby sheets are aligned. However, if the sheet arrives farther than the target landing location or arrives nearer than the target landing location when discharged, there is a problem that accuracy of the alignment is lowered.

### DESCRIPTION OF THE DRAWINGS

FIG. 1 is an external view illustrating an entire configuration example of an image forming system of an embodiment.

FIG. 2 is a configuration view illustrating a functional configuration relating to a discharging process of a post-processing apparatus of the embodiment.

FIG. 3 is a configuration view illustrating the functional configuration relating to the discharging process of the post-processing apparatus of the embodiment.

FIG. 4 is a view illustrating a first example of a sensor.

FIG. 5 is a view illustrating a second example of the sensor.

FIG. 6 is a view illustrating a specific example of a discharging mechanism.

FIG. 7 is a block diagram of hardware components of the post-processing apparatus used in controlling the discharging mechanism.

FIG. 8 is a view illustrating a specific example sheet positions on a discharge tray.

FIG. 9 is a flow chart illustrating a flow of a process carried out by a control unit of the post-processing apparatus.

FIG. 10 is a view illustrating a modification example of the discharging mechanism.

### DETAILED DESCRIPTION

A post-processing apparatus of an embodiment includes a discharge tray, a sheet conveyor configured to convey a sheet onto the discharge tray, a drive unit configured to drive the sheet conveyor, a sensor configured to detect a position of the sheet discharged onto the discharge tray, and a control unit configured to determine a parameter to control the drive unit based on an output of the sensor, and to control the drive unit based on the determined parameter.

Hereinafter, the post-processing apparatus of an embodiment will be described with reference to the drawings.

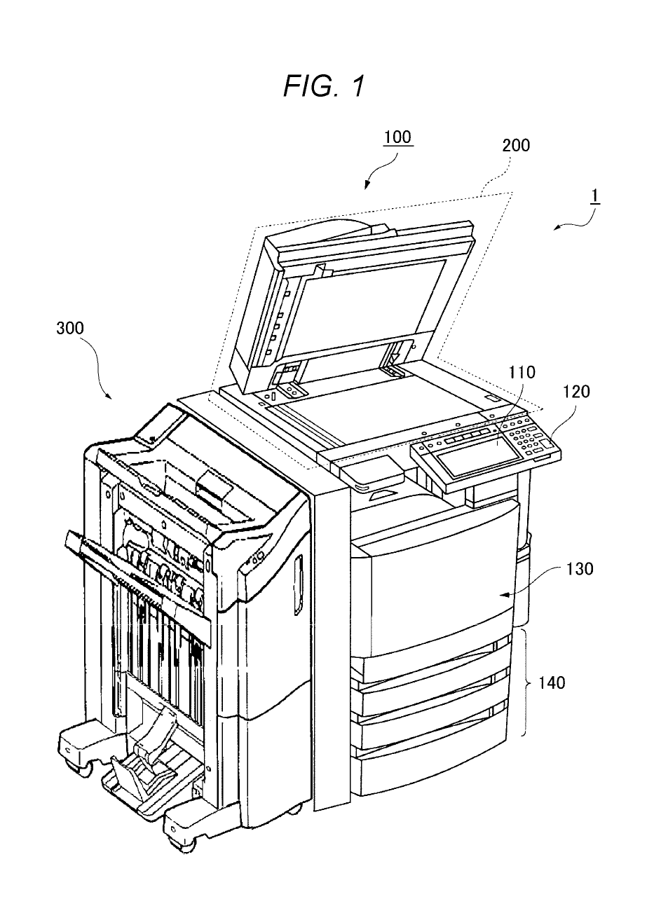

FIG. 1 is an external view illustrating an entire configuration example of an image forming system 1 of the embodiment. The image forming system 1 includes an image forming apparatus 100 and a post-processing apparatus 300.

The image forming apparatus 100 is, for example, a multi-function peripheral. The image forming apparatus 100 includes a display 110, a control panel 120, a printer unit 130, a sheet housing unit 140, and an image reading unit 200. The image forming apparatus 100 forms an image on a sheet using a developer such as toner. The sheet is, for example, paper or label paper. The sheet may be any material as long as the image forming apparatus 100 can form an image on a surface thereof.

The post-processing apparatus 300 is connected to the image forming apparatus 100. The post-processing apparatus 300 performs a post-processing with respect to the sheet on which an image is formed by the image forming apparatus 100. As a specific example of the post-processing executed by the post-processing apparatus 300, there is a processing such as sort processing, punch processing, staple processing, and binding processing.

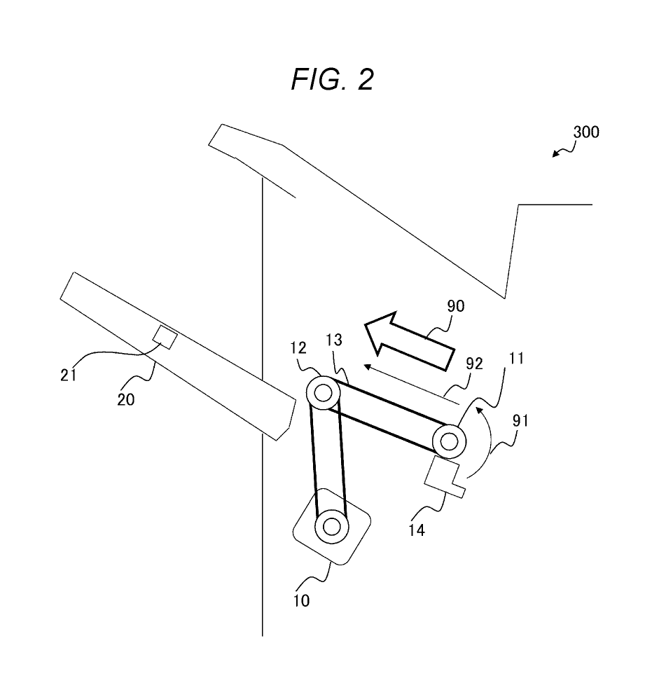

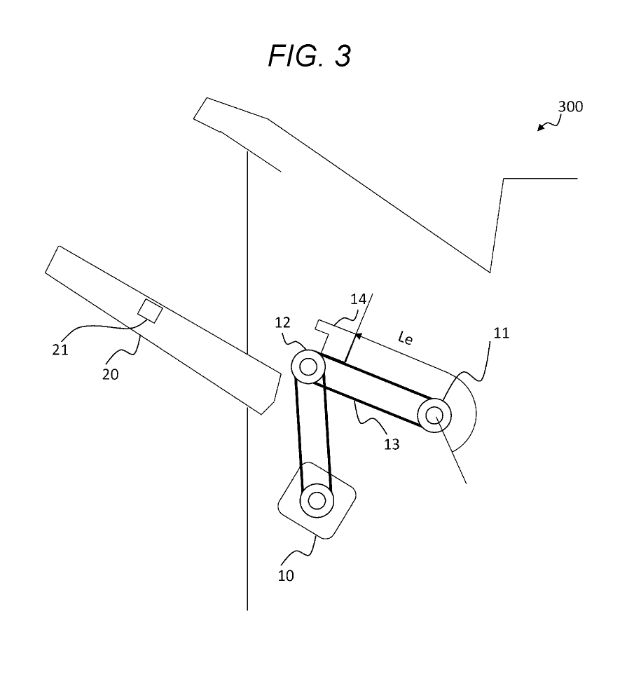

FIGS. 2 and 3 are views illustrating a functional configuration relating to a discharging process of the post-processing apparatus 300 of the embodiment. In FIG. 2, the image forming apparatus 100 is positioned on the right side of the post-processing apparatus 300. The post-processing apparatus 300 includes a drive unit 10, a sheet conveyor comprising a first conveying roller 11, a second conveying roller 12, a discharge belt 13, and a discharge claw 14. The post-processing apparatus 300 further includes a discharge tray 20 and a sensor 21.

The drive unit 10 is a driving device such as a motor. The drive unit 10 drives a discharging mechanism provided in the post-processing apparatus 300. The discharging mechanism is a mechanism that conveys the sheet to discharge the sheet from the post-processing apparatus 300. The drive unit 10 rotates, for example, a predetermined shaft. Rotational motion generated by the drive unit 10 is transmitted to the second conveying roller 12 via a drive belt, for example. Moreover, the drive unit 10 provided in the post-processing apparatus 300 is not required to be one, as illustrated in FIG. 2. The drive unit 10 provided in the post-processing apparatus 300 may be provided in plural numbers.

The first conveying roller 11 rotates to apply a force to the sheet to be discharged so that it is moved toward a direction of the discharge tray 20 (hereinafter, referred to as “discharge direction”). The first conveying roller 11 rotates according to the drive signal from the drive unit 10. Moreover, the discharge direction is a direction indicated by an arrow 90 of FIG. 2. An operation (for example, rotation) of the drive unit 10 is controlled to control the rotational speed of the first conveying roller 11.

The second conveying roller 12 rotates to apply a force to the sheet to be discharged so that it is moved in the discharge direction. The second conveying roller 12 rotates according to the drive signal from the drive unit 10. The operation (for example, rotation) of the drive unit 10 is controlled to control the rotational speed of the second conveying roller 12.

The discharge belt 13 is a belt which is mounted around the first conveying roller 11 and the second conveying roller 12. The first conveying roller 11 and the second conveying roller 12 rotate at the same peripheral speed by the discharge belt 13. Moreover, each of the first conveying roller 11 and the second conveying roller 12 may have a mechanism that is rotated at an independent speed. If each of the belt and the roller can be independently driven, a formula determining a parameter is individually established.

The discharge claw 14 moves along a path through which the sheet passes when the sheet is discharged. The discharge claw 14 moves and pushes the sheet in the discharging direction. FIG. 2 illustrates the discharge claw 14 in a case where it is positioned at a standby position. FIG. 3 illustrates the discharge claw 14 in a case where it is positioned at a stop position after the discharge claw 14 pushes the sheet. The discharge claw 14 is configured to move from the standby position shown in FIG. 2 to the stop position shown in FIG. 3 thereby pushing the sheet in the discharge direction. A specific example of the movement of the discharge claw 14 will be described. The discharge claw 14 is moved to an upper side of the discharge belt 13 from the standby position along an arrow 91 in FIG. 2. Next, the discharge claw 14 is moved in the discharge direction along an arrow 92 in FIG. 2. Thus, the discharge claw 14 moves toward the stop position and stops at the stop position.

The discharge tray 20 is a tray on which the sheets, which are discharged by the discharging mechanism such as the first conveying roller 11, are stacked. The sheets are stacked on the discharge tray 20 in the order of its being discharged.

The sensor 21 detects the sheet discharged to the discharge tray 20. The sensor 21 maybe a sensor for detecting the light and darkness of light such as a Charge Coupled Device (CCD). In this case, the brightness that is obtained by the sensor 21 is changed based on the number of the sheets stacked on the discharge tray 20. The sensor 21 may detect the sheet according to the change.

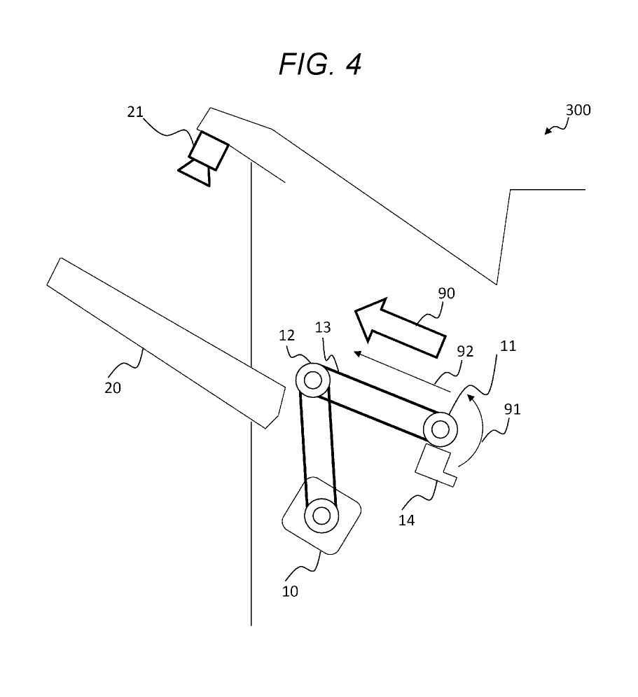

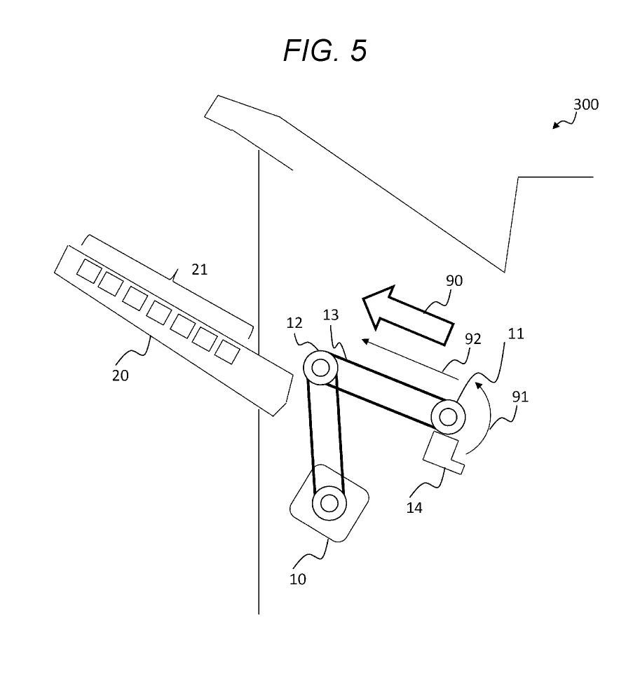

FIGS. 4 and 5 illustrate specific examples of the sensor 21. For example, as illustrated in FIG. 4, the sensor 21 may be configured as a CCD camera. In this case, the sensor 21 may be disposed so as to image an upper surface side of the discharge tray 20. The sensor 21 may detect the discharged sheet based on an image data which is read by the sensor 21. For example, as illustrated in FIG. 5, the sensor 21 may be configured with sensing elements such as a plurality of CCDs. In this case, the sensing elements are arranged along an inclined upper surface of the discharge tray 20. The sensor 21 may detect the position of the sheet on the discharge tray 20 based on the light and darkness of each element.

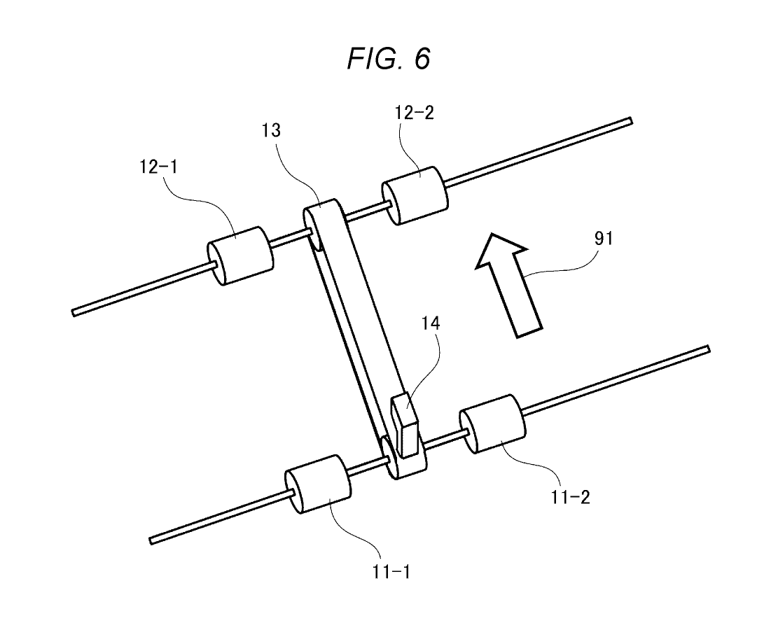

FIG. 6 is a view illustrating a specific example of the discharging mechanism. For example, two first conveying rollers 11 and second conveying rollers 12 may be respectively provided. As illustrated in FIG. 6, a first left conveying roller 11-1, a first right conveying roller 11-2, a second left conveying roller 12-1, and a second right conveying roller 12-2 may be provided. In addition, the discharge claw 14 may be provided on the discharge belt 13 which is configured to move along the discharge direction (direction indicated with the arrow 91). In this case, the discharge claw 14 is moved in accordance with the movement of the discharge belt 13.

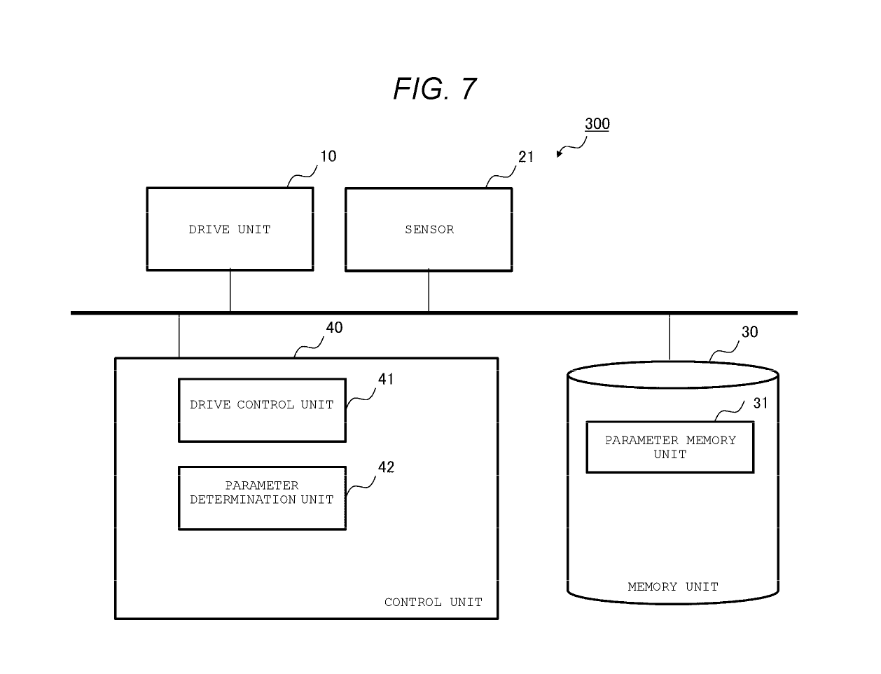

FIG. 7 is a block diagram of hardware components of the post-processing apparatus 300 used in controlling the discharging mechanism. The post-processing apparatus 300 includes the drive unit 10, the sensor 21, a memory unit 30, and a control unit 40. The description of the drive unit 10 and the sensor 21 will be omitted because of the description is the same as the above.

The memory unit 30 is a storage device such as cache or memory. The memory unit 30 functions as a parameter memory unit 31. The parameter memory unit 31 stores parameters that the control unit 40 uses for controlling the drive unit 10. Specific examples of the parameters stored in the parameter memory unit 31 include a rotational speed, a rotation time, the number of rotations of a motor of the drive unit 10, and the like.

The control unit 40 is implemented as a CPU that executes a program to function as a drive control unit 41 and a parameter determination unit 42.

The drive control unit 41 controls the operation of the drive unit 10. The drive control unit 41 controls the drive unit 10, for example, when the post-processing apparatus 300 discharges the sheet. The drive control unit 41 controls the drive unit 10 based on the parameters stored in the parameter memory unit 31 when controlling the drive unit 10.

The parameter determination unit 42 determines parameters about the operation of the drive unit 10 based on a detection result of the sensor 21. The parameter determination unit 42 estimates an actual behavior of the discharged sheet, for example, based on the detection result of the sensor 21 and may determine the parameters based on an estimation result. The actual behavior of the discharged sheet is obtained, for example, as an output result of the sensor 21. That is, the parameter determination unit 42 determines the parameters about the operation of the drive unit 10 based on the output result of the sensor 21. The parameter determination unit 42 stores the determined parameters in the parameter memory unit 31.

Details of processing of the parameter determination unit 42 will be described. The parameter determination unit 42 determines parameters based on which the discharged sheet will reach a predetermined position (hereinafter, referred to as a “reference position”) that is determined in advance. For example, the parameters are determined so as to cause an arrival position of the discharged sheet to be nearer to the sheet conveyor if the sensor output indicating that the arrival position of the discharged sheet is farther from the sheet conveyor than the reference position is obtained. In this case, the parameter determination unit 42 changes the rotational speed, the rotation time, or the number of rotations to be smaller value. For example, the parameters are determined so as to cause an arrival position of the discharged sheet to be farther from the sheet conveyor if the sensor output indicating that the arrival position of the discharged sheet is nearer to the sheet conveyor than the reference position is obtained. In this case, the parameter determination unit 42 changes the rotational speed, the rotation time, or the number of rotations to be greater value.

Formulas 1 to 4 are the specific examples of the formulas for determining the parameters.

Vr=dVrt1(t1−t1i)+dVrt2(t2−t2i)+Vrset (Formula 1)

Tr=dTrt1(t1−t1i)+dTrt2(t2−t2i)+Trset (Formula 2)

Ve=dVet1(t1−t1i)+dVet2(t2−t2i)+Veset (Formula 3)

Le=dLet1(t1−t1i)+dLet2(t2−t2i)+Leset (Formula 4)

Each value of Formulas described above is as follows.
Vr: rotational speed of the second conveying roller 12
Tr: rotation time of the second conveying roller 12
Ve: moving speed of the discharge claw 14
Le: moving distance of the discharge claw 14
Vrset: default value of the rotational speed of the second conveying roller 12 which is determined in advance for each type of the sheet
Trset: default value of the rotation time of the second conveying roller 12 which is determined in advance for each type of the sheet
Veset: default value of the moving speed of the discharge claw 14 which is determined in advance for each type of the sheet
Leset: default value of the moving distance of the discharge claw 14 which is determined in advance for each type of the sheet
dVrt1, dTrt2, dVet1, dVet2: speed increment coefficient
dLet1, dLet2: distance increment coefficient
dTrt1, dTrt2: rotation time increment coefficient
t1: actual measured time from when the sheet is discharged from the second conveying roller 12 to when the leading end of the sheet arrives at a predetermined position (for example, the position of the sensor 21)
t2: actual measured time from when the leading end of the sheet arrives at the predetermined position to when the sheet slides down on the discharge tray 20 and the leading end of the sheet passes through a predetermined position
t1i: ideal value of a time from when the sheet is discharged from the second conveying roller 12 to when the leading end of the sheet arrives at the predetermined position (for example, the position of the sensor 21)
t2i: ideal value of a time from when the leading end of the sheet arrives at the predetermined position to when the sheet slides down on the discharge tray 20 and the leading end of the sheet passes through a predetermined position

Among the values described above, Vr, Tr, Ve, and Le are the parameters controlled by the control unit 40. Among the values described above, two ideal values (t1i and t2i) are values that are set such that the leading end of the sheet arrives at the reference position. The two ideal values may be set in advance according to the type of the sheet. Each value may be obtained in addition, by an experiment and the like. The parameter determination unit 42 may determine the parameters based on the following Formulas 5 to 8.

Vr=dVrt1(t1−t1i)+dVrx1(x1−x1i)+dVrt2(t2−t2i)+dVrx2(x2−x2i)+Vrset (Formula 5)

Tr=dTrt1(t1−t1i)+dTrx1(x1−x1i)+dTrt2(t2−t2i)+dTrx2(x2−x2i)+Trset (Formula 6)

Ve=dVet1(t1−t1i)+dVex1(x1−x1i)+dVet2(t2−t2i)+dVex2(x2−x2i)+Veset (Formula 7)

Le=dLet1(t1−t1i)+dLex1(x1−x1i)+dLet2(t2−t2i)+dLex2(x2−x2i)+Leset (Formula 8)

Each value of Formulas 5 to 8 described above is as follows. Moreover, in Formulas 5 to 8, values common to Formulas 1 to 4 are the same as those of Formulas 1 to 4.
x1: actual measured position where the leading end of the sheet discharged from the second conveying roller 12 arrives
x2: actual measured position of the leading end of the sheet at a time when the sheet stops after the sheet slides down on the discharge tray 20
x1i: ideal value of a position where the leading end of the sheet discharged from the second conveying roller 12 arrives
x2i: the ideal value of a position of the leading end of the sheet at a time when the sheet stops after the sheet slides down on the discharge tray 20

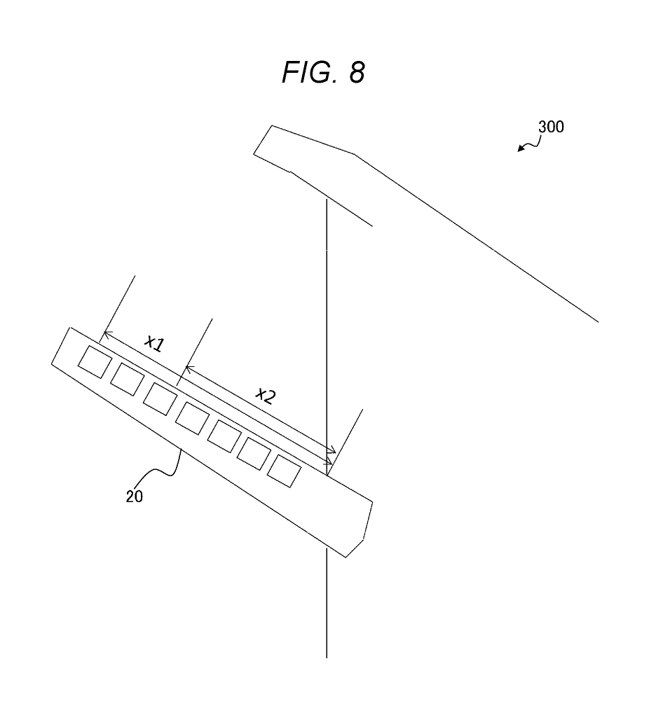

FIG. 8 is a view illustrating a specific example of the x1 and the x2. As illustrated in FIG. 8, the x1 and the x2 may be obtained as a distance from a contact point between the discharge tray 20 and the post-processing apparatus.

The four ideal values may be set in advance according to the type of the sheet. Each value may be obtained in advance by an experiment or the like. The parameter determination unit 42 may determine the parameters based on Formulas 5 to 8 described above.

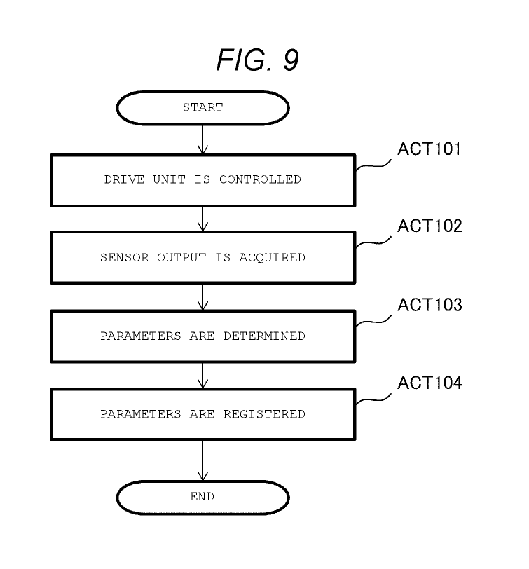

FIG. 9 is a flow chart illustrating a flow of processing by the control unit 40. First, the drive control unit 41 controls the drive unit 10 using a value of a parameter stored in the parameter memory unit 31 when performing the discharging process of the sheet (ACT 101). The drive control unit 41 drives the drive unit 10 and thereby the first conveying 11 and the second conveying roller 12 are rotated, and the discharge claw 14 is moved. The sheet is discharged on the discharge tray 20 in accordance with the rotation of the first conveying roller 11 and the second conveying roller 12, and the movement of the discharge claw 14. The sensor 21 detects the sheet discharged on the discharge tray 20. The sensor 21 outputs a signal indicating the detection result. The parameter determination unit 42 acquires an output (sensor output) of the sensor 21 (ACT 102). The parameter determination unit 42 determines the parameters based on the sensor output (ACT 103). Thus, the parameter determination unit 42 stores values of the parameters that are newly determined in the parameter memory unit 31 (ACT 104). In the next discharging process, the discharging process is executed based on new values of the parameters stored in the parameter memory unit 31.

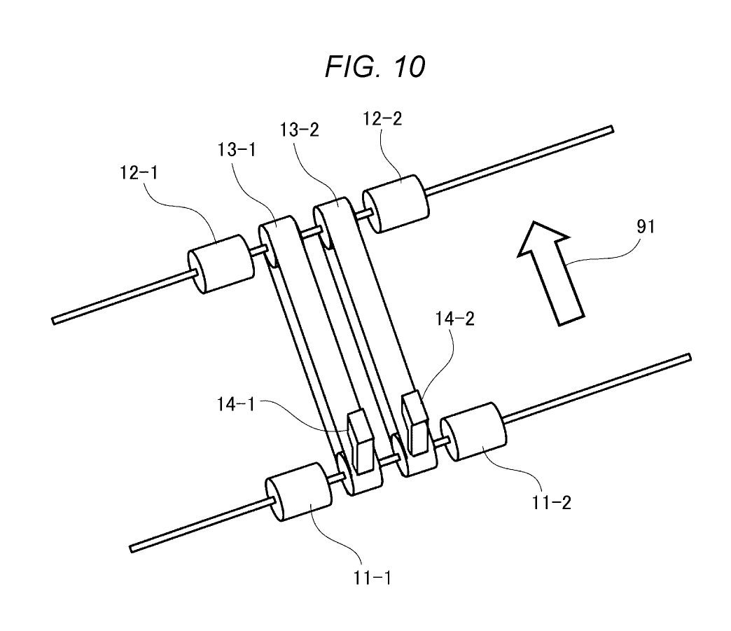

FIG. 10 is a view illustrating a modification example of the discharging mechanism. For example, the post-processing apparatus 300 may include a plurality of the discharge claws 14. For example, two discharge claws 14 may be provided between the first conveying roller 11 and the second conveying roller 12.

The drive control unit 41 may control each of the left and right first conveying rollers 11 and second conveying rollers 12 such that the rotational speeds thereof are different from each other. It is possible to control the skew of the discharged sheet by controlling the first conveying roller 11 and the second conveying roller 12 as described above. For example, if a right end of the sheet discharged to the discharge tray 20 is landed on near the front (discharge direction) than a left end thereof, the rotational speeds of the first left conveying roller 11-1 and the second left conveying roller 12-1 may be controlled to be faster.

According to at least one embodiment described above, the drive unit is controlled such that the sheet arrives at the reference position for aligning the sheet using the drive control unit. Specifically, the parameters of the drive unit are updated based on the actual measured values such as the arrival position and the arrival time of the sheet. Therefore, it is possible to align the arrival position of the sheet to the reference position that is set in advance to maintain the accuracy of the alignment. As a result, it is possible to prevent the accuracy of the alignment from being lowered.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. A post-processing apparatus comprising:
a discharge tray;
a sheet conveyor configured to convey a sheet onto the discharge tray;
a drive unit configured to drive the sheet conveyor;
a sensor configured to detect a position of the sheet discharged onto the discharge tray; and
a control unit configured to determine a parameter to control the drive unit based on an output of the sensor, and to control the drive unit based on the determined parameter.

2. The apparatus according to claim 1, wherein the sheet conveyor includes
a conveying roller that is rotated according to a drive signal from the drive unit, the conveying roller causing the sheet to be discharged onto the discharge tray at different positions depending on a rotating speed of the conveying roller.

3. The apparatus according to claim 1, wherein the sheet conveyor includes:
a claw configured to engage the sheet placed on the sheet conveyor and discharge the engaged sheet onto the discharge tray.

4. The apparatus according to claim 1, wherein the control unit determines the parameter such that the sheet discharged onto the discharge tray is placed at a predetermined reference position.

5. The apparatus according to claim 4, wherein
the control unit determines the parameter so as to cause the sheet conveyor to reduce a sheet conveying speed if the sensor indicates that the position of the discharged sheet on the discharge tray is farther from the sheet conveyor than the reference position.

6. The apparatus according to claim 4, wherein
the control unit determines the parameter so as to cause the sheet conveyor to increase a sheet conveying speed if the sensor indicates that the arrival position of the discharged sheet on the discharge tray is nearer to the sheet conveyor than the reference position.

7. The apparatus according to claim 1, wherein
the control unit determines the parameter based on an actual measured time from when the sheet is discharged by the sheet conveyor to when a leading end of the sheet reaches a first predetermined position and an actual measured time from when the leading end of the sheet reaches the first predetermined position to when the sheet slides down on the discharge tray and the leading end of the sheet passes through a second predetermined position.

8. The apparatus according to claim 1, wherein
the control unit unit determines the parameter based on a measured time from when the leading end of the sheet reaches a first predetermined position to when the sheet slides down on the discharge tray and the leading end of the sheet passes through a second predetermined position.

9. The apparatus according to claim 1, wherein the discharge tray has an inclined upper surface onto which the sheet is discharged from the sheet conveyor, and the sensor includes a plurality of sensing elements arranged along the inclined upper surface.

10. A control method that is performed by a post-processing apparatus including a discharge tray, a sheet conveyor configured to convey a sheet onto the discharge tray, a drive unit configured to drive the sheet conveyor, and a sensor configured to detect a position of the sheet discharged onto the discharge tray, the method comprising:
determining a parameter to control the drive unit based on an output of the sensor; and
controlling the drive unit based on the determined parameter.

11. The method according to claim. 10, wherein the sheet conveyor includes a conveying roller that is rotated according to a drive signal from the drive unit, the conveying roller causing the sheet to be discharged onto the discharge tray at different positions depending on a rotating speed of the conveying roller.

12. The method according to claim 10, wherein the post-processing apparatus further includes a claw configured to engage the sheet placed on the sheet conveyor and discharge the engaged sheet onto the discharge tray.

13. The method according to claim 10, wherein the parameter is determined such that the sheet discharged onto the discharge tray is placed at a predetermined reference position.

14. The method according to claim 13, wherein the parameter is determined so as to cause the sheet conveyor to reduce a sheet conveying speed if the sensor indicates that the position of the discharged sheet on the discharge tray is farther from the sheet conveyor than the reference position.

15. The method according to claim 13, wherein the parameter is determined so as to cause the sheet conveyor to increase a sheet conveying speed if the sensor indicates that the position of the discharged sheet on the discharge tray is nearer to the sheet conveyor than the reference position.

16. The method according to claim 10, wherein the parameter is determined based on an actual measured time from when the sheet is discharged by the sheet conveyor to when a leading end of the sheet reaches a first predetermined position and an actual measured time from when the leading end of the sheet reaches the first predetermined position to when the sheet slides down on the discharge tray and the leading end of the sheet passes through a second predetermined position.

17. The method according to claim 10, wherein the parameter is determined based on a measured time from when the leading end of the sheet reaches a first predetermined position to when the sheet slides down on the discharge tray and the leading end of the sheet passes through a second predetermined position.

18. The method according to claim 10, wherein the discharge tray has an inclined upper surface onto which the sheet is discharged from the sheet conveyor, and the sensor includes a plurality of sensing elements arranged along the inclined upper surface.

19. A post-processing apparatus comprising:
a discharge tray;
a sheet conveyor belt driven by rollers and configured to convey a sheet onto the discharge tray;
a drive unit configured to drive the rollers;
a plurality of sheet sensors arranged on the discharge tray; and
a control unit configured to determine a parameter to control the drive unit based on an output of the sensors, and to control the drive unit based on the determined parameter.

20. The apparatus according to claim 19, wherein the control unit controls the drive unit to drive the rollers at a lower speed if the sensors indicate that the position of the discharged sheet on the discharge tray is farther from the sheet conveyor than a reference position, and at a higher speed if the sensors indicate that the position of the discharged sheet on the discharge tray is near to the sheet conveyor than the reference position.
